(19) United States
(12) Patent Application Publication
(10) Pub. No.: US 2007/0149737 A1
(43) Pub. Date: Jun. 28, 2007

(54) Method of producing water-soluble nonturbid copolymers of at least one water-soluble n-vinyllactam and at least one hydrophobic comonomer

(75) Inventors: Rainer Dobrawa, Mannheim (DE); Ralf Widmaier, Mannheim (DE); Eberhard Schupp, Grunstadt (DE); Klaus Schnell, Neustadt (DE); Karl-Hermann Strube, Speyer (DE); Jurgen Nieberle, Wachenheim (DE); Bernd de Potzolli, Bad Durkheim (DE); Andreas Gruber, Altrip (DE); Reinhold Dieing, Speyer (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/643,395

(22) Filed: Dec. 21, 2006

(30) Foreign Application Priority Data
Dec. 23, 2005 (DE) 10 2005 062 663.7

(51) Int. Cl. C08F 26/10

(52) U.S. Cl. 526/264; 526/319; 526/330

(57) ABSTRACT

Method of producing vinyllactam copolymers by free-radical polymerization of at least one water-soluble N-vinyllactam and at least one hydrophobic comonomer in an organic solvent in the presence of an initiator under reflux conditions, where at least 10 mol % of the N-vinyllactam are added to the polymerization mixture when at least 90 mol % of the hydrophobic monomer have completely reacted.

### BACKGROUND OF THE INVENTION

The present invention relates to a method of producing water-soluble copolymers of at least one water-soluble N-vinyllactam and at least one hydrophobic comonomer by free-radical polymerization of the monomers in an organic solvent, and to the copolymers obtainable by the method and their use.

The production of copolymers from N-vinyllactams and hydrophobic comonomers by free-radical polymerization is known. The production of such copolymers takes place in an organic solvent, for example an alcohol or in a mixture of water and organic solvent with a high content of solvent. Usually, the polymerization is carried out under reflux of the solvent. The hydrophobic monomers that are more readily volatile compared to the N-vinyllactams pass in this way into the gas phase and into the condensate.

For many application purposes, copolymers are desired which dissolve in water to give clear solutions, i.e. the FNU value of a 5% strength by weight solution should be <20. However, there is the problem that differing reactivities and differing polarity of the monomers can lead to increases in the concentration of the hydrophobic monomers which results in homopolymers which are not water-soluble being able to be formed from the hydrophobic monomers. Even in small amounts in the range from 500 to 1000 ppm, such homopolymers lead to turbidity of an aqueous solution of the copolymers. The increases in concentration of hydrophobic monomers can arise in particular in the gas phase and in the condensate, and also on the reactor wall and the surface of the polymerization medium.

U.S. Pat. No. 5,395,904 describes the polymerization of vinylpyrrolidone and vinylacetate by controlled polymerization according to the feed method. An alcoholic solvent is used which can comprise up to 50% by weight of water.

U.S. Pat. No. 5,319,041 describes the preparation of copolymers of vinylpyrrolidone and vinyl acetate by polymerization according to the feed method with control of the polymerization temperature.

U.S. Pat. No. 5,502,136 describes a method of producing copolymers of vinylpyrrolidone and vinyl acetate according to the feed method, where the feeds are controlled via a scheme defined by specific mathematical formulae.

U.S. Pat. No. 4,520,179 and U.S. Pat. No. 4,554,311 describe the polymerization of vinylpyrrolidone and vinyl acetate with t-butyl peroxypivalate as initiator in water or water/alcohol mixtures. The initiator used therein allows the production of copolymers with a narrow molecular weight distribution, that does not lead to water-soluble products with a FNU value of <20.

EP-A 161 describes a method of producing copolymers of vinylpyrrolidone and vinyl acetate where, after the polymerization, an after polymerization with specific initiators is carried out. However, the polymers have high residual contents of vinyl acetate and are not sufficiently nonturbid.

EP-A 795 567 describes the production of copolymers of vinyllactams and hydrophobic monomers by polymerization in aqueous solution.

EP-A discloses the production of copolymers of vinylpyrrolidone and vinyl esters which dissolve in water to give clear solutions, where, at a certain point during the polymerization, a solvent exchange is carried out in order to remove volatile constituents. This method is relatively complex.

DE-A 22 18 935 describes the copolymerization of N-vinylpyrrolidone with various water-soluble and water-insoluble comonomers. Use is made here of water-insoluble initiators which are used in the form of a finely divided suspension in an aqueous solution of the copolymers. However, in the case of the water-insoluble comonomers, this does not likewise lead to the desired water-soluble copolymers with a FNU value of <20.

### BRIEF SUMMARY OF THE INVENTION

The object of the present invention is therefore to provide an improved method of producing clearly water-soluble copolymers of at least one hydrophilic N-vinyllactam and at least one hydrophobic comonomer by free-radical copolymerization in an organic solvent.

According to the invention, the object is achieved by free-radical polymerization of at least one water-soluble N-vinyllactam and at least one hydrophobic comonomer in an organic solvent in the presence of an initiator under reflux conditions, wherein at least 5 mol % of the N-vinyllactam are added to the polymerization mixture when at least 90 mol % of the hydrophobic monomer have completely reacted.

### DETAILED DESCRIPTION OF THE INVENTION

Suitable water-soluble vinyllactams are N-vinylpyrrolidone, 3-methyl-N-vinylpyrrolidone, 4-methyl-N-vinylpyrrolidone, 5-methyl-N-vinylpyrrolidone, N-vinylpyridone, N-vinylpiperidone, N-vinylcaprolactam, preferably N-vinylpyrrolidone. The vinyllactams are used in amounts of from 30 to 90% by weight, preferably 50 to 90% by weight.

The method according to the invention is suitable for producing water-soluble polymers of monomer mixtures whose content of hydrophobic monomers is in the range from 10 to 70% by weight, preferably 10 to 50% by weight, based on the monomer mixture. Suitable hydrophobic monomers are those with a solubility in water in the range from 1 to 100 g/l. Suitable hydrophobic monomers are, for example, vinyl acetate, vinyl propionate, methyl acrylate, ethyl acrylate, n-propyl acrylate, n-butyl acrylate, t-butyl acrylate, methyl methacrylate, ethyl methacrylate, acrylonitrile or methacrylonitrile. The hydrophobic monomers are in particular those whose boiling points at atmospheric pressure are in the range of the polymerization temperature from 60 to 130° C., so that they can evaporate under polymerization conditions. Even at a boiling point slightly below the polymerization temperature, the hydrophobic monomer can pass into the gas phase with a solvent which boils under the polymerization conditions if there is adequate miscibility with the solvent. The hydrophobic monomer can here pass into the gas phase as an azeotropic mixture with the solvent or as a physical mixture with the solvent. A preferred hydrophobic monomer is vinyl acetate.

Free-radical initiators which may be mentioned are, for example, dialkyl or diaryl peroxides, such as di-tert-amyl peroxide, dicumyl peroxide, bis(tert-butylperoxyisopropyl)benzene, 2,5-bis(tert-butylperoxy)-2,5-dimethylhexane, tert-butyl cumene peroxide, 2,5-bis(tert-butylperoxy)-2,5-dimethyl-3-hexene, 1,1-bis(tert-butylperoxy)-3,3,5-trimethylcyclohexane, 1,1 -bis(tert-butylperoxy)cyclohexane, 2,2-bis(tert-butylperoxy)butane or di-tert-butyl peroxide, aliphatic and aromatic peroxy esters, such as cumyl peroxyneodecanoate, 2,4,4-trimethylpentyl 2-peroxyneodecanoate, tert-amyl peroxyneodecanoate, tert-butyl peroxyneodecanoate, tert-amyl peroxypivalate, tert-butyl peroxypivalate, tert-amyl peroxy-2-ethylhexanoate, tert-butyl peroxy-2-ethylhexanoate, tert-butyl peroxydiethylacetate, 1,4-bis(tert-butylperoxy)cyclohexane, tert-butyl peroxyisobutanoate, tert-butyl peroxy-3,5,5-trimethylhexanoate, tert-butyl peroxyacetate, tert-amyl peroxybenzoate or tert-butyl peroxybenzoate, dialkanoyl or dibenzoyl peroxides, such as diisobutanoyl peroxide, bis(3,5,5-trimethylhexanoyl) peroxide, dilauroyl peroxide, didecanoyl peroxide, 2,5-bis(2-ethylhexanoylperoxy)-2,5-dimethylhexane or dibenzoyl peroxide, and peroxycarbonates, such as bis(4-tert-butylcyclohexyl) peroxydicarbonate, bis(2-ethylhexyl) peroxydicarbonate, di-tert-butyl peroxydicarbonate, diacetyl peroxydicarbonate, dimyristyl peroxydicarbonate, tert-butyl peroxyisopropylcarbonate or tert-butyl peroxy-2-ethylhexylcarbonate. Readily oil-soluble azo initiators used are, for example, 2,2′-azobis(isobutyronitrile), 2,2′-azobis(2,4-dimethylvaleronitrile) or 4,4′-azobis(4-cyanopentanoic acid).

The free-radical initiator used is preferably a compound chosen from the group comprising tert-butyl peroxy-2-ethylhexanoate (Trigonox® 21; Trigonox® grades from Akzo Nobel), tert-amyl peroxy-2-ethylhexanoate (Trigonox® 121), tert-butyl peroxybenzoate (Trigonox® C), tert-amyl peroxybenzoate, tert-butyl peroxyacetate (Trigonox® F), tert-butyl peroxy-3,5,5-trimethylhexanoate (Trigonox® 42 S), tert-butyl peroxyisobutanoate, tert-butyl peroxydiethylacetate (Trigonox® 27), tert-butyl peroxypivalate (Trigonox® 25), tert-butyl peroxyisopropylcarbonate, (Trigonox® BPIC), 2,5-dimethyl-2,5-di(tert-butylperoxy)hexane (Trigonox® 101), di-tert-butyl peroxide (Trigonox® B), cumyl hydroperoxide (Trigonox® K) and tert-butyl peroxy-2-ethylhexylcarbonate (Trigonox® 117). It is of course also possible to use mixtures of the abovementioned free-radical initiators.

The amount of initiator used, based on the monomers, is in the range from 0.02 to 15 mol %, preferably 0.05 to 3 mol %. In the method according to the invention, the initiator is used as solution, depending on the solubility, in a C1-C4-alcohol. In these solutions the initiator concentration is in the range from 0.02 to 2 mol %, preferably 0.1 to 2 mol %, based on the solvent.

A suitable polymerization medium is a polar organic solvent. The solvent must be so hydrophilic that it is miscible with the vinyllactam in any mixing ratio. In addition, the solvent should boil under the polymerization conditions so that a reflux can form. Of suitability are, for example, aliphatic or aromatic halogenated hydrocarbons, such as chloroform, carbon tetrachloride, hexachloroethane, dichloroethane, tetrachloroethane, chlorobenzene, and liquid C1- or C2-chlorofluorohydrocarbons, aliphatic C2- to C5-nitriles, such as acetonitrile, propionitrile, butyronitrile or valeronitrile, linear or cyclic aliphatic C3- to C7-ketones, such as acetone, methyl ethyl ketone, methyl isobutyl ketone, 2- or 3-hexanone, 2-, 3-, or 4-heptanone, cyclopentanone, cyclohexanone, linear or cyclic aliphatic ethers, such as diisopropyl ether, 1,3- or 1,4-dioxane, tetrahydrofuran or ethylene glycol dimethyl ether, carbonates, such as diethyl carbonate, and lactones, such as butyrolactone, valerolactone or caprolactone. Suitable mono-, di- or polyhydric alcohols are, in particular, the C1- to C8-alcohols, the C2- to C8-alkanediols, and C3- to C10-tri- or polyols. Examples thereof are methanol, ethanol, n-propanol, isopropanol, n-butanol, sec-butanol, tert-butanol, n-pentanol, 2-pentanol, 3-pentanol, and ethylene glycol, propylene glycol or 1,3-propanediol.

The monoalkoxy alcohols used are, in particular, the abovementioned C1- to C8-alcohols and C2- to C8-alkanediols, and C3- to C10-triols substituted by a C1- to C6-alkoxy group. Examples thereof are methoxymethanol, 2-methoxyethanol, 2-methoxypropanol, 3-methoxypropanol, 2-methoxybutanol, 3-methoxybutanol, 4-methoxybutanol, 2-ethoxyethanol, 2-ethoxypropanol, 3-ethoxypropanol, 2-ethoxybutanol, 3-ethoxybutanol, 4-ethoxybutanol, 2-isopropoxyethanol, 2-isopropoxypropanol, 3-isopropoxypropanol, 2-isopropoxybutanol, 3-isopropoxybutanol, 4-isopropoxybutanol, 2-(n-propoxy)ethanol, 2-(n-propoxy)propanol, 3-(n-propoxy)propanol, 2-(n-propoxy)butanol, 3-(n-propoxy)butanol, 4-(n-propoxy)butanol, 2-(n-butoxy)ethanol, 2-(n-butoxy)propanol, 3-(n-butoxy)propanol, 2-(n-butoxy)butanol, 3-(n-butoxy)butanol, 4-(n-butoxy)butanol, 2-(sec-butoxy)ethanol, 2-(sec-butoxy)propanol, 3-(sec-butoxy)propanol, 2-(sec-butoxy)butanol, 3-(sec-butoxy)butanol, 4-(sec-butoxy)butanol, 2-(tert-butoxy)ethanol, 2-(tert-butoxy)propanol, 3-(tert-butoxy)propanol, 2-(tert-butoxy)butanol, 3-(tert-butoxy)butanol, 4-(tert-butoxy)butanol.

Of particular suitability is a C1- to C4-alcohol, preferably ethanol or isopropanol. Particular preference is given to using isopropanol as solvent.

The polymerization is usually carried out at a neutral pH in the range from 5 to 9. If necessary, the pH is adjusted and/or maintained by adding a base, such as ammonia, triethylamine, triethanolamine or sodium hydroxide solution, or an acid, such as hydrochloric acid, lactic acid, oxalic acid, acetic acid or formic acid.

If relatively low molecular weights are desired, these can be established by adding a regulator to the polymerization mixture. Suitable regulators are, for example, aldehydes, such as formaldehyde, acetaldehyde, propionaldehyde, n-butyraldehyde and isobutyraldehyde, formic acid, ammonium formate, hydroxylammonium sulfate and hydroxylammonium phosphate. In addition, regulators can be used which comprise sulfur in organically bonded form. These are, for example, di-n-butyl sulfide, di-n-octyl sulfide, diphenyl sulfide, diisopropyl disulfide, di-n-butyl disulfide, di-n-hexyl disulfide, diacetyl disulfide and di-t-butyl trisulfide. Preferably, the regulators comprise sulfur in the form of SH groups. Examples of such regulators are n-butyl mercaptan, n-hexyl mercaptan or n-dodecyl mercaptan. Particular preference is given to water-soluble, sulfur-containing polymerization regulators, such as, for example, hydrogen sulfites, disulfites and compounds such as ethyl thioglycolate, cysteine, 2-mercaptoethanol, 1,3-mercaptopropanol, 3-mercaptopropane-1,2-diol, 1,4-mercaptobutanol, mercaptoacetic acid, 3-mercaptopropionic acid, mercaptosuccinic acid, thioglycerol, diethanol sulfide, thiodiglycol, ethylthioethanol, thiourea and dimethyl sulfoxide. Further suitable regulators are allyl compounds, such as allyl alcohol or allyl bromide, benzyl compounds, such as benzyl chloride or alkyl halides, such as chloroform or tetrachloromethane. In a preferred embodiment, the regulator is metered into the reaction mixture, if appropriate, as a solution in a C1-C4-alcohol.

The method according to the invention is carried out so that at least 10 mol % of the N-vinyllactam are added to the polymerization mixture when at least 90 mol % of the hydrophobic monomer have completely reacted.

In the method according to the invention, the monomers, if appropriate as solution in a C1-C4-alcohol, are metered into the reaction mixture (feed method). In one embodiment of the invention, up to 20 mol %, preferably up to 15 mol %, in particular up to 10 mol % of the water-soluble N-vinyllactam I (based on the total amount of N-vinyllactam I) and a small amount of the initiator solution and solvent, preferably ethanol or isopropanol, are initially introduced. Then, the mixture is brought to the reaction temperature and the remaining amount of monomer is metered in continuously or in several portions at the same time as the remainder of initiator solution and, if appropriate, a regulator. In general, the metered addition takes place over a period of from 2 to 14 hours, preferably 3 to 12 hours, ideally 4 to 11 hours (depending on the batch size used and concentration. The concentration of the monomers in the reaction mixture is in the range from 10 to 80% by weight, preferably 20 to 75% by weight, in particular 25 to 70% by weight, based on the reaction mixture. In this case, after the reaction mixture has been brought to the desired reaction temperature, the initiator solution is allowed to run in continuously or in several portions, in particular over a period of from 2.5 to 16 hours, preferably 3.5 to 14 hours, in particular 5 to 12.5 hours.

Following polymerization of at least 90 mol % of the amount of hydrophobic monomer to be used in total for the polymerization, a further amount I of 5 to 25 mol % of the amount of vinyllactam to be used in total for the polymerization is added in a way such that the addition takes place continuously with a linear or variable material stream or batchwise in several portions, this amount I being added so that the addition of the amount I of vinyllactam is complete after 110 to 150% of the total addition time of the hydrophobic monomer. If the addition takes place continuously with a variable material stream, then at least 60% of this amount I is added to the reaction mixture within 50% of the addition time of the amount I. If the addition of the amount I takes place batchwise in several portions, then this amount is divided, depending on the absolute addition time in hours, into a number of 3 to 7 equally sized portions so that likewise at least 60% of this amount I can be added to the reaction mixture within 50% of the addition time of the amount I, where the addition of the first portion is added to the reaction mixture at the time zero of the addition time of the amount I. If the addition takes place continuously with a linear material stream, then 5 to 10% of the total amount of the amount I can likewise be added batchwise to the reaction mixture at the time zero of the addition time of the amount I before the continuous metered addition is started.

Besides this method according to the invention, further known methods for minimizing the turbidity of the polymer solutions according to the invention can be combined with this method provided they do not contradict this method described here.

The polymerization reaction is carried out under reflux conditions. In this connection, reflux conditions means that the liquid polymerization mixture boils and the readily volatile components, such as the solvent and/or hydrophobic monomers, evaporate and condense again as a result of cooling. Reflux conditions are maintained by controlling temperature and pressure.

The reaction temperature is usually in the range from 60 to 90° C., however it can also be up to 130° C. The reaction can be carried out at atmospheric pressure, under autogenous pressure or under protective-gas gage pressure. In the case of protective-gas gage pressure, the pressure is regulated so that boiling is still always present. The person skilled in the art can determine suitable pressure ranges using the relative vapor pressures. Usually, the pressure here will not exceed 2 MPa. The polymerization can take place at a pressure of 0.05 to 2 MPa, preferably 0.08 to 1.2 MPa, in particular 0.1 to 0.8 MPa.

The polymerization takes place in a boiler equipped with a stirring device. Suitable stirring devices are anchor stirrers, propeller stirrers, cross-blade stirrers, Mik stirrers, or other stirrers suitable for solution polymerization or which are known to the person skilled in the art. In addition, one or more feed devices for metering the monomers, the initiator solution, and, if appropriate, the regulator (solutions) are also present.

In addition, the boiler, in the upper region of the reactor where no liquid polymerization mixture but a gas phase, is present, is equipped with a condenser.

Under the polymerization conditions, on account of their lower boiling points, solvents and/or hydrophobic monomers pass in part into the gas phase, whereas the higher-boiling N-vinyllactam remains in the liquid polymerization phase. Depending on the choice of the solvent, the gas phase can also consist only of hydrophobic monomers. In the condenser, the gaseous phase of solvent and/or hydrophobic monomers condenses and thus forms the so-called reflux.

After the polymerization reaction, if desired, one or more polymerization initiators are added and the polymer solution is heated, e.g. to the polymerization temperature or to temperatures above the polymerization temperature, in order to complete the polymerization. Of suitability are the azo initiators stated above, but also all other customary initiators suitable for a free-radical polymerization in alcoholic solution, for example peroxides, hydroperoxides, peroxodisulfates, percarbonates, peroxoesters and hydrogen peroxide. Through this, the polymerization reaction is conducted to a conversion of 99.9%. The solutions which form during the polymerization usually comprise 10 to 70% by weight, preferably 15 to 60% by weight, of polymer. After the polymerization, the solutions obtained can also be subjected to a physical after treatment, for example steam distillation or stripping with nitrogen, with the solvent or impurities volatile with steam being removed from the solution. In addition, the solutions may also be subjected to a chemical after-treatment or bleaching with hydrogen peroxide, sodium sulfite/tert-butyl hydroperoxide and the like.

The aqueous solutions of the copolymer obtained by steam distillation can, if appropriate, be converted into solid powders by a drying process corresponding to the prior art. Suitable drying processes are those which are suitable for drying from aqueous solution. Preferred processes are, for example, spray-drying, spray fluidized-bed drying, drum-drying and belt-drying. Freeze-drying and freeze-concentration can likewise be used.

With the help of the method according to the invention, it is ensured that a uniform concentration of both comonomers can always be maintained and no concentration of only one of the monomers takes place, in order, as described, to prevent the formation of water-insoluble homopolymers.

The polymers obtained generally have a K value (determined at 25° C. in a 1% strength by weight aqueous or ethanolic solution) in the range from 10 to 100, in particular 15 to 90 and particularly preferably 20 to 80. Determination of the K value is described in H. Fikentscher “Systematik der Cellulosen auf Grund ihrer Viskosität in Lösung” [systematics of the celluloses based on their viscosity in solution], Cellulose-Chemie 13 (1932), 58-64 and 71-74, and Encyclopedia of Chemical Technology, Vol. 21, 2nd edition, 427-428 (1970).

A measure of their clear solubility is the nephelometric turbidity unit FNU (or NTU), which is measured at 25° C. in a 5% strength by weight aqueous solution of the polymer and is fixed by calibration with formazin as artificial opacifier. The precise method is given in the course of the examples below. The polymers obtained according to the invention have a FNU value of <20, in particular <10, preferably <7 and particularly preferably <5.

The polymers obtained by the method according to the invention are used in particular in cosmetic and pharmaceutical preparations, for example as thickeners or film formers in hair lacquer additives, hair setting additives or hairspray additives, in skin cosmetic preparations, immunochemicals or as active ingredient-releasing agent in pharmaceutical preparations. In addition, the polymers produced according to the invention can be used as auxiliaries for agrochemistry, for example for seed coating or for slow-release fertilizer formulations. The polymers are also suitable as coatings for industrial applications, for example for the coating of paper or plastics or for hot-melt adhesives. Furthermore, these polymers are suitable as binders for transfer printing, as lubricant additives, as rust inhibitors or rust removers from metallic surfaces, as scale inhibitors or scale removers, as auxiliaries during the recovery of petroleum from oil-containing water, as auxiliaries during the production of petroleum and natural gas, and the transportation of petroleum and natural gas, as cleaners of waste-waters, as adhesive raw materials, as detergent additives, and as auxiliaries in the photo industry.

The examples listed below are intended to illustrate the invention without, however, limiting it.

### EXAMPLES

The turbidity of the aqueous copolymer solution was determined by nephelometric turbidity measurement (modified method according to DIN 38404). In this method, the light scattered by the measurement solution is determined photometrically, light scattering being caused by the interaction between the light beams and the particles or droplets in the solution, the number and size of which constitute the degree of turbidity. The quantity being measured here is the nephelometric turbidity unit FNU (or NTU), which is measured at 25° C. in a 5% strength by weight aqueous solution of the polymer and is fixed by calibration with formazin as artificial opacifier. The higher the FNU value, the more turbid the solution.

### General Procedure Examples 1 to 5

| Feed material allocation | | | |
|---|---|---|---|
| Initial charge | of feed 1 | see examples | |
| | of feed 2 | see examples | |
| Feed 1 | isopropanol | 230 | ml |
| | vinylpyrrolidone | see examples | |
| | vinyl acetate | see examples | |
| Feed 2 | isopropanol | 30 | ml |
| | tert-butyl perpivalate 75% | 2 | g |
| Feed 3 | vinylpyrrolidone | see examples | |
| Feed 4 | isopropanol | 30 | ml |
| | tert-butyl perpivalate 75% | 1 | g |
| | (Trigonox 25) | | |

The polymerization took place in a stirred reactor with a volume of 21. The initial charge was flushed with nitrogen for 10 min then heated to the polymerization temperature T (° C.) (internal temperature). At T minus 10% (° C.), feeds 1 and 2 were started. Feed 1 was metered in over v hours, feed 2 over x hours. Feed 3 was metered in as stated over y hours. The mixture was then after-polymerized for a hours. When feed 2 was complete, the mixture was heated to an internal temperature of T plus 10-15% (° C.). Feed 4 was then metered in at 80° C. over z hours. When feed 4 was complete, the mixture was after-polymerized for a further b hours at T plus 10-15% (° C.). The solvent was then firstly removed by thermal distillation and then by steam distillation, and the stated solids content was established by adding water.

Solids content in % by weight

K value measured 1% strength in ethanol

GC analysis: vinylpyrrolidone in ppm; vinyl acetate in ppm;

Appearance: color, viscosity, clarity (FNU value)

The data in mol % refer to the total amount of the feed substance in question.

### Example 1

| | | |
|---|---|---|
| VP/VAc = 55.5:44.5 | mol | mol % |

| | | | |
|---|---|---|---|
| Initial charge: | VP | 0.142 | 8.471 |
| | VAc | 0.173 | 9.953 |
| Feed 1 | VP | 1.286 | 76.634 |
| | VAc | 1.563 | 90.047 |
| Feed 3 | VP | 0.250 | 14.895 |

Polymerization temperature: 78° C.
Feed times: feed 1: v = 4 h feed 3: y = 2 h
Start of feed 3: after the end of feed 1
Initiator feed: feed 2: x = 6 h feed 4: z = 0.5 h
After-polymerization: a = 2 h, b = 1 h
Solids content in % by wt.: 35.4
K value 32.4, measured 1% strength in ethanol
GC analysis: vinylpyrrolidone <50 ppm; vinyl acetate <50 ppm;
Appearance: slightly yellowish, clear, FNU value: 8

### Example 2

| | | |
|---|---|---|
| at VP/VAc = 70:30 | mol | mol % |

| | | | |
|---|---|---|---|
| Initial charge: | VP | 0.179 | 7.807 |
| | VAc | 0.116 | 9.050 |
| Feed 1 | VP | 1.801 | 78.465 |
| | VAc | 1.171 | 90.950 |
| Feed 3 | VP | 0.315 | 13.727 |

Polymerization temperature: 78° C.
Feed times: feed 1: v = 3.5 h feed 3: y = 1.5 h
Start of feed 3: after the end of feed 1
Initiator feed: feed 2: x = 5.5 h feed 4: z = 0.5 h
After-polymerization: a = 2 h, b = 1 h
Solids content in % by wt.: 37.1
K value 30.5, measured 1% strength in ethanol
GC analysis: vinylpyrrolidone <50 ppm; vinyl acetate 62 ppm;
Appearance: slightly yellowish, clear, FNU value: 1

### Example 3

| | | |
|---|---|---|
| at VP/VAc = 30:70 | mol | mol % |

| | | | |
|---|---|---|---|
| Initial charge: | VP | 0.077 | 7.807 |
| | VAc | 0.272 | 9.050 |
| Feed 1 | VP | 0.772 | 78.465 |
| | VAc | 2.732 | 90.950 |
| Feed 3 | VP | 0.135 | 13.727 |

Polymerization temperature: 78° C.
Feed times: feed 1: v = 5 h feed 3: y = 2.5 h
Start of feed 3: 4.5 h after the start of feed 1
Initiator feed: feed 2: x = 7.5 h feed 4: z = 1 h
After-polymerization: a = 2 h, b = 1.5 h
Solids content in % by wt.: 36.3
K value 33.7, measured 1% strength in ethanol
GC analysis: vinylpyrrolidone <51 ppm; vinyl acetate 71 ppm;
Appearance: yellowish, clear, FNU value: 9

### Example 4

| | | |
|---|---|---|
| at VP/VAc = 60:40 | mol | mol % |

| | | | |
|---|---|---|---|
| Initial charge: | VP | 0.154 | 7.807 |
| | VAc | 0.155 | 9.050 |
| Feed 1 | VP | 1.544 | 78.465 |
| | VAc | 1.561 | 90.950 |
| Feed 3 | VP | 0.270 | 13.727 |

Polymerization temperature: 78° C.
Feed times: feed 1: v = 4 h feed 3: y = 1.8 h
Start of feed 3: after the end of feed 1
Initiator feed: feed 2: x = 6 h
Feed 4: z = 1 h, 3 portions (time zero, after 25 min, after 1 h)
After-polymerization: a = 2 h, b = 1.5 h
Solids content in % by wt.: 32.8
K value 34.2, measured 1% strength in ethanol
GC analysis: vinylpyrrolidone <50 ppm; vinyl acetate <50 ppm;
Appearance: slightly yellowish, clear, FNU value: 3

### Example 5

| | | |
|---|---|---|
| at VP/VAc = 50:50 | mol | mol % |

| | | | |
|---|---|---|---|
| Initial charge: | VP | 0.128 | 7.807 |
| | VAc | 0.194 | 9.050 |
| Feed 1 | VP | 1.286 | 78.465 |
| | VAc | 1.951 | 90.950 |
| Feed 3 | VP | 0.225 | 13.727 |

Polymerization temperature: 78° C.
Feed times: feed 1: v = 4.5 h feed 3: y = 2 h
Start of feed 3: 4 h after the start of feed 1
Initiator feed: feed 2: x = 6.5 h feed 4: z = 1 h
After-polymerization: a = 2 h, b = 1.5 h
Solids content in % by wt.: 34.3
K value 31.4, measured 1% strength in ethanol
GC analysis: vinylpyrrolidone <50 ppm; vinyl acetate <50 ppm;
Appearance: slightly yellowish, clear, FNU value: 2

What is claimed is:

1. A method of producing vinyllactam copolymers, the method comprising:
(a) providing at least one water-soluble N-vinyllactam and at least one hydrophobic comonomer; and
(b) free-radical polymerizing the at least one water-soluble N-vinyllactam and the at least one hydrophobic comonomer in an organic solvent in the presence of an initiator under reflux conditions, wherein at least 10 mol % of the N-vinyllactam is added to the polymerization mixture after at least 90 mol % of the hydrophobic monomer has completely reacted.

2. The method according to claim 1, wherein the hydrophobic comonomer comprises a monomer having a solubility in water of 1 to 100 g/l.

3. The method according to claim 1, wherein the hydrophobic comonomer comprises a monomer having a boiling point at atmospheric pressure of 60 to 150° C.

4. The method according to claim 2, wherein the hydrophobic comonomer comprises a monomer having a boiling point at atmospheric pressure of 60 to 150° C.

5. The method according to claim 1, wherein the hydrophobic comonomer comprises a monomer selected from the group consisting of vinyl acetate, vinyl propionate, methyl acrylate, ethyl acrylate, n-propyl acrylate, n-butyl acrylate, t-butyl acrylate, methyl methacrylate, ethyl methacrylate, acrylonitrile, methacrylonitrile, and mixtures thereof.

6. The method according to claim 4, wherein the hydrophobic comonomer comprises a monomer selected from the group consisting of vinyl acetate, vinyl propionate, methyl acrylate, ethyl acrylate, n-propyl acrylate, n-butyl acrylate, t-butyl acrylate, methyl methacrylate, ethyl methacrylate, acrylonitrile, methacrylonitrile, and mixtures thereof.

7. The method according to claim 1, wherein the hydrophobic comonomer comprises vinyl acetate.

8. The method according to claim 4, wherein the hydrophobic comonomer comprises vinyl acetate.

9. The method according to claim 1, wherein the N-vinyllactam comprises N-vinylpyrrolidone.

10. The method according to claim 8, wherein the N-vinyllactam comprises N-vinylpyrrolidone.

11. The method according to claim 1, wherein the polymerization is carried out at a temperature of 60 to 150° C.

12. The method according to claim 10, wherein the polymerization is carried out at a temperature of 60 to 150° C.

13. The method according to claim 1, wherein the organic solvent comprises an alcohol.

14. The method according to claim 12, wherein the organic solvent comprises an alcohol.
